(19) United States
(12) Patent Application Publication
(10) Pub. No.: US 2024/0214149 A1
(43) Pub. Date: Jun. 27, 2024

(54) METHOD AND DEVICE FOR DESIGNING REFERENCE SIGNAL FOR PHASE NOISE ESTIMATION IN ORTHOGONAL FREQUENCY DIVISION MULTIPLEXING SCHEMES

(71) Applicant: Electronics and Telecommunications Research Institute, Daejeon (KR)

(72) Inventors: Kyeong Pyo KIM, Daejeon (KR); Woo Ram SHIN, Daejeon (KR); Young Jo KO, Daejeon (KR); Kap Seok CHANG, Daejeon (KR)

(73) Assignee: Electronics and Telecommunications Research Institute, Daejeon (KR)

(21) Appl. No.: 18/543,894

(22) Filed: Dec. 18, 2023

(30) Foreign Application Priority Data
Dec. 16, 2022 (KR) 10-2022-0177155
Dec. 1, 2023 (KR) 10-2023-0172355

(51) Int. Cl. H04L 5/00; H04B 17/336; H04W 28/26

(52) U.S. Cl. CPC H04L 5/0051; H04B 17/336; H04W 28/26; H04L 5/0007

(57) ABSTRACT

According to an embodiment of the present disclosure, a method of designing a reference signal for phase noise estimation in an orthogonal frequency division multiplexing (OFDM) communication system, the method comprising: acquiring a magnitude of a frequency bandwidth of phase noise; acquiring a magnitude of a subcarrier; comparing the magnitudes of the subcarrier and the frequency bandwidth; selecting one of a first phase compensation scheme and a second phase compensation scheme based on the comparison result, and inserting the reference signal into an OFDM symbol based on the selected phase compensation scheme; and transmitting the OFDM symbol including the reference signal.

### CROSS-REFERENCE TO RELATED APPLICATION

The present application claims priority to Korean Patent Application No. 10-2022-0177155, filed on Dec. 16, 2022 and Korean Patent Application No. 10-2023-0172355, filed on Dec. 1, 2023, in the Korea Intellectual Property Office, the entire contents of which are incorporated herein by reference.

### TECHNICAL FIELD

The present disclosure relates to a method and device for designing reference signals for phase noise estimation in orthogonal frequency division multiplexing (OFDM) schemes.

### BACKGROUND

The content described below simply provides background information related to the present disclosure and does not constitute prior art.

A wireless communication system is a system in which a transmitter wirelessly transmits a signal modulated in a specific way, and a receiver receives it and demodulates it to extract a desired signal.

FIG. 1 is an exemplary diagram of analog signal processing in a carrier frequency band.

In general, as shown in FIG. 1, a wireless communication system performs signal processing by modulating or demodulating an analog signal in a carrier frequency band into a baseband signal and then converting it into a digital signal. When converting the analog signal in the carrier frequency band into a baseband signal, the oscillation frequency generated by an oscillator is used, and when the oscillation frequency is not constant and varies randomly, a phase deviation occurs accordingly. This is called phase noise, and the estimation and compensation process of phase noise is one of the factors that determine the performance of the communication system.

There are various methods for estimating phase noise, and the representative method is to estimate phase noise using signals agreed upon in advance by a transmitter and a receiver. In this case, the signal agreed upon between the transmitter and the receiver in advance is called a reference signal, and the phase difference between the transmitted signal and the received signal is estimated by exchanging this reference signal through a wireless environment. Generally, the transmitter modulates the reference signal and transmits it through the wireless environment, and the receiver demodulates the transmitted signal distorted by the wireless environment and phase noise and compares it with the original reference signal. In this case, the receiver estimates the phase noise by appropriately processing the difference between the original reference signal and the distorted signal received by the receiver and extracting only the distortion component caused by the phase noise.

The reference signal for estimating phase noise varies depending on the modulation scheme of the wireless communication system. The representative wireless communication systems, such as wireless LAN systems and cellular communication systems, modulate signals using the OFDM scheme.

The OFDM scheme is a scheme of dividing a time-domain signal into certain unit magnitudes and then spreading each unit magnitude time-domain signal using a Fourier sequence, which takes advantage of the fact that when the time-domain signal is spread with the Fourier sequence, it is converted into a frequency-domain signal. The OFDM modulation process first allocates or generates a desired signal in the frequency domain, divides it into certain unit magnitudes, spreads it using an inverse Fourier sequence, converts it into a time-domain signal, and then transmits the signal through a wireless environment. Since the OFDM modulation scheme allocates signals in the frequency domain, it is more convenient to process signals in the frequency domain rather than the time domain where the signals are actually transmitted wirelessly.

Therefore, in the OFDM system, the design and allocation of reference signals for channel estimation is also done in the frequency domain, and the phase noise estimation process is also generally performed in the frequency domain. The phase noise in the OFDM modulation scheme is largely divided into CPE (Common Phase Error) and ICI (Inter-Carrier Interference).

In the CPE scheme, the CPE component can be removed by placing a plurality of reference signals for phase noise estimation within an OFDM symbol, extracting the phase noise component they have in common, and then compensating for all subcarriers within the OFDM symbol.

The ICI scheme is to design the OFDM symbol with large subcarrier interval to prevent ICI from occurring from the beginning. In this case, most of the effects of phase noise can be eliminated by only compensating for the CPE.

Techniques for removing ICI are to estimate the frequency spectrum of the phase noise after channel estimation and equalization are accurately performed. When channel estimation is not performed properly, the reliability of the frequency spectrum of the estimated phase noise is lowered.

### SUMMARY

In view of the above, the present disclosure provides a method and device for designing reference signal to increase reliability of frequency spectrum estimation of phase noise by reducing channel estimation error when using an OFDM modulation scheme in a multiple transmission/reception point environment.

The objects to be achieved by the present disclosure are not limited to the objects mentioned above, and other objects not mentioned may be clearly understood by those of ordinary skill in the art from the following description.

According to an embodiment of the present disclosure, a method of designing a reference signal for phase noise estimation in an orthogonal frequency division multiplexing (OFDM) communication system, the method comprising: acquiring a magnitude of a frequency bandwidth of phase noise; acquiring a magnitude of a subcarrier; comparing the magnitudes of the subcarrier and the frequency bandwidth; selecting one of a first phase compensation scheme and a second phase compensation scheme based on the comparison result, and inserting the reference signal into an OFDM symbol based on the selected phase compensation scheme; and transmitting the OFDM symbol including the reference signal.

According to an embodiment of the present disclosure, a device of A device for designing a reference signal for phase noise estimation in an orthogonal frequency division multiplexing (OFDM) communication system, the device comprising: a memory including instructions; and a processor that executes the instructions to: obtain a magnitude of a frequency bandwidth of phase noise; obtain a magnitude of a subcarrier; compare the magnitudes of the subcarrier and the frequency bandwidth; select one of a first phase compensation scheme and a second phase compensation scheme based on the comparison result, and insert the reference signal into an OFDM symbol based on the selected phase compensation scheme; and transmit the OFDM symbol including the reference signal.

According to an embodiment of the present disclosure, a method of designing a reference signal for phase noise estimation in an orthogonal frequency division multiplexing (OFDM) communication system, the method comprising: receiving a signal; extracting a reference signal from the signal; and estimating an OFDM symbol based on the reference signal, wherein the OFDM symbol is generated by acquiring a magnitude of a frequency bandwidth of phase noise, acquiring a magnitude of a subcarrier, comparing the magnitudes of the subcarrier and the frequency bandwidth, selecting one of a first phase compensation scheme and a second phase compensation scheme based on the comparison result, inserting the reference signal into an OFDM symbol based on the selected phase compensation scheme, and transmitting the OFDM symbol including the reference signal.

The present disclosure can increase the reliability of frequency spectrum estimation of phase noise by reducing channel estimation error when using the OFDM modulation method in a multi-transmission/reception point environment.

The present disclosure can control the resource allocation method of the reference signal according to the frequency spectrum characteristics of phase noise and the subcarrier interval of OFDM method in a multi-antenna and multi-transmission/reception point environment.

The present disclosure can improve phase noise estimation performance and distortion compensation performance of a received signal in a corresponding environment.

### BRIEF DESCRIPTION OF THE DRAWINGS

FIG. 1 is an exemplary diagram of analog signal processing in a carrier frequency band.

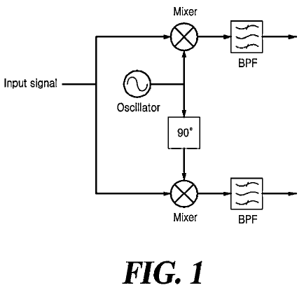

FIG. 2 is an example diagram of symbol placement in an OFDM system.

FIG. 3 is an example diagram showing phase noise time response and frequency spectrum.

FIG. 4 is a constellation diagram of a received signal distorted by phase noise.

FIG. 5 is an example diagram of reference signal allocation for phase noise estimation.

FIG. 6 is an example diagram of allocating a reference signal for phase noise estimation.

FIG. 7 is an example diagram of a single transmission/reception point multiple antenna environment.

FIG. 8 is an example diagram of symbol allocation in an OFDM system in a single transmission/reception point multiple antenna environment.

FIG. 9 is an example diagram of a multiple transmission/reception point environment with a single antenna.

FIG. 10 is an example diagram of symbol allocation in an OFDM scheme in the multiple transmission/reception point environment with a single antenna.

FIG. 11 is an example diagram of spectrum estimation of phase noise with a wide band using received subcarriers.

FIG. 12 is a first example diagram showing a reference signal allocation scheme of the OFDM modulation/demodulation scheme in a multiple transmission/reception point environment according to one embodiment of the present disclosure.

FIG. 13 is a second example diagram showing the reference signal allocation scheme of the OFDM modulation/demodulation scheme in the multiple transmission/reception point environment according to one embodiment of the present disclosure.

FIG. 14 is a flowchart showing a method of determining a resource allocation scheme based on a frequency spectrum of phase noise according to one embodiment of the present disclosure.

### DETAILED DESCRIPTION

In describing the components of embodiments according to the present disclosure, symbols such as first, second, i), ii), a), and b) may be used. These symbols are only used to distinguish one component from another, and the nature, sequence, or order of the component is not limited by the symbol. In the present specification, when it is described that a part ‘includes’ or ‘has’ a component, this means that the part may further include other components without excluding other elements, unless explicitly described to the contrary.

The detailed description set forth below in conjunction with the accompanying drawings is intended to describe exemplary embodiments of the present disclosure and is not intended to represent the only embodiments in which the present disclosure may be practiced.

In the present specification, “subcarrier magnitude” may be referred to as “subcarrier interval.”

In embodiments of the present disclosure, when the subcarrier magnitude is less than the magnitude of a bandwidth of a frequency spectrum of phase noise, by making the environments experienced by the reference signal used when estimating the residual phase noise after channel estimation and the data symbol similar, the estimation performance of the frequency spectrum of the residual phase noise is improved. The bandwidth of the frequency spectrum of phase noise may be referred to as the phase noise bandwidth.

In embodiments of the present disclosure, by controlling the resource allocation scheme of the reference signal according to the frequency spectrum characteristics of the phase noise and the subcarrier interval of the OFDM scheme in a multi-antenna and multi-transmission/reception point environment, phase noise estimation performance and distortion compensation performance of the received signal in the corresponding environment is improved.

The phase noise in the OFDM modulation scheme is largely divided into CPE (Common Phase Error) and ICI (Inter-Carrier Interference). The frequency-time domain system model for checking phase noise in the OFDM modulation scheme satisfies the following Equation 1.

yₗ^{t}=Pₗ^{t}Hₗ^{t}(F_{N})^{H}D_{N}xₗ^{ft} (Equation 1)

Where, FN is an N×N DFT (Discrete Fourier Transform) matrix, and the noise component of the receiver is omitted to facilitate background description. In Equation 1, the l-th frequency-time domain transmission signal is xᵢ^{ft}=[x₀,l^{ft}, x₁,l^{ft}, . . . , xₘ,l^{ft}, . . . , x_{M-1,l}^{ft}]^{T} and yₗ^{t} is the l-th time y domain reception signal. The main distortion components, the l-th time domain phase noise matrix Pₗ^{t} and the channel matrix Hₗ^{t} may be expressed in the form of Equation 2.

$${P}_{l}^{t} = diag ( {e}^{j {ϕ}_{0 , l}^{t}} , {e}^{j {ϕ}_{1 , l}^{t}} , … , {e}^{j {ϕ}_{m , l}^{t}} , … , {e}^{j {ϕ}_{N - 1 , l}^{t}} ) \qquad ( Equation 2 )$$

$${H}_{l}^{t} [ \begin{matrix}{h}_{0 , l}^{t} & {h}_{N - 1 , l}^{t} & ⋰ & {h}_{1 , l}^{t} \\ {h}_{1 , l}^{t} & {h}_{0 , l}^{t} & {h}_{N - 1 , l}^{t} & ⋰ \\ ⋰ & {h}_{1 , l}^{t} & {h}_{0 , l}^{t} & {h}_{N - 1 , l}^{t} \\ {h}_{N - 1 , l}^{t} & ⋰ & {h}_{1 , l}^{t} & {h}_{0 , l}^{t}\end{matrix} ]$$

In the channel matrix of Equation 2, [h_{0,l}^{t}, h_{1,l}^{t}, . . . ,h_{m,l}^{t}, . . . h_{N-1,l}^{t}] is the time domain channel impulse response. In the system model equation of Equation 1, D_{N} is an N×M mapping matrix, and all row vectors in this matrix are all filled with ‘0’ except for one ‘1’, and at the same time, all column vectors in this matrix have no more than one ‘1’ component.

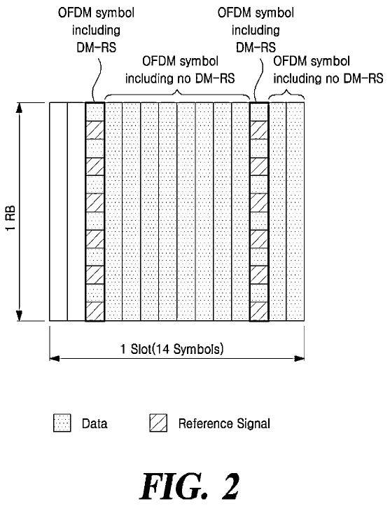

FIG. 2 is an example diagram of symbol placement in an OFDM system.

Referring to FIG. 2, assuming that there exists a reference signal for channel estimation of the OFDM system, such as DM-RS (DeModulate Reference Signal) of 5G NR or the like, the following assumptions can be made in general.
1) An OFDM symbol including a reference signal for channel estimation exists.
2) Channel estimation is performed in the OFDM symbol including the reference signal for channel estimation.
3) The time frequency of the OFDM symbol including the reference signal for channel estimation is determined according to the change rate of the channel. That is, when the channel changes very quickly, the reference signal for channel estimation may be included in every OFDM symbol, and when the channel changes slowly, the temporal frequency of the OFDM symbol including the reference signal for channel estimation may be low.
4) According to the above-described assumption, channel estimation in an OFDM symbol that does not include a reference signal for channel estimation can utilize the value estimated in the immediately previous OFDM symbol including the reference signal for channel estimation.

FIG. 2 is an example diagram of symbol placement in the OFDM modulation/demodulation scheme.

If the OFDM symbol including the channel estimation reference signal is called the l-th symbol, and the OFDM symbol including no channel estimation reference signal is called the 1′-th symbol, the effective channel and channel equalization matrix estimated in the l-th OFDM symbol can be expressed as follows.

Ĥₗ^{f}=F_{N}Pₗ^{t}Hₗ^{t}(F_{N})^{H}D_{N}=Pₗ^{f}Hₗ^{f}D_{N}Gₗ^{f}=(D_{N})^{T}Qₗ^{f}(Pₗ^{f})⁻¹ (Equation 3)

When the l′-th received OFDM symbol including no channel estimation reference signal is equalized using the effective channel estimation and equalization matrix of Equation 3, it can be expressed as Equation 4.

\hat{x}_{l′}^{ft}=Gₗ^{f}F_{N}y_{l′}^{t}=(D_{N})^{T}Qₗ^{f}(Pₗ^{f})⁻¹P_{l′}^{f}H_{l′}^{f}D_{N}x_{l′}^{ft}=Q_{M,l}^{f}\tilde{P}_{M,l′}^{f}H_{M,l′}^{f}x_{l′}^{ft} (Equation 4)

In Equation 4, Q_{M,L}^{f}=(D_{N})^{T}Qₗ^{f}D_{N} represents the channel equalization matrix, \tilde{P}_{M,l′}^{f}=(D_{N})^{T}(Pₗ^{f})⁻¹P_{l′}^{f}D_{N} represents the residual phase noise matrix, and H_{M,l′}^{f}=(D_{N})^{T}H_{l′}^{f}D_{N} represents the channel matrix.

Since the rate of change of the channel is already reflected in the time frequency of the OFDM symbol including the channel estimation reference signal, it can be assumed that the channel in the l′-th OFDM symbol as well as the channel in the l-th OFDM symbol is approximately the same as the channel in the l-th OFDM symbol. In addition, since it can be assumed that there is no channel change within one OFDM symbol, Q_{M,l}^{f} and H_{M,l′}^{f} may be viewed as diagonal matrices. Further, the residual phase noise matrix has the form of a circular matrix as follows.

$${\tilde{P}}_{M , l}^{f} = [ \begin{matrix}{\tilde{p}}_{0 , l}^{f} & {\tilde{p}}_{1 , l}^{f} & ⋰ & {\tilde{p}}_{- 1 , l}^{f} \\ {\tilde{p}}_{- 1 , l}^{f} & {\tilde{p}}_{0 , l}^{f} & {\tilde{p}}_{1 , l}^{f} & ⋰ \\ ⋰ & {\tilde{p}}_{- 1 , l}^{f} & {\tilde{p}}_{0 , l}^{f} & {\tilde{p}}_{1 , l}^{f} \\ {\tilde{p}}_{1 , l}^{f} & ⋰ & {\tilde{p}}_{- 1 , l}^{f} & {\tilde{p}}_{0 , l}^{f}\end{matrix} ] \qquad ( Equation 5 )$$

In Equation 5, the value of

[|\tilde{p}−_{(M/2),l}^{ft}|2, . . . ,|\tilde{p}_{-1,l}^{ft}|²,|\tilde{p}_{0,l}^{f}|²,|\tilde{p}_{1,l}^{f}|², . . . ,|\tilde{p}_{(M/2)-1,l}^{ft}|²]

corresponds to the frequency power spectrum of the residual phase noise, and the value of |\tilde{p}_{0,l}^{f}|² is the residual phase noise power value when the frequency offset is zero.

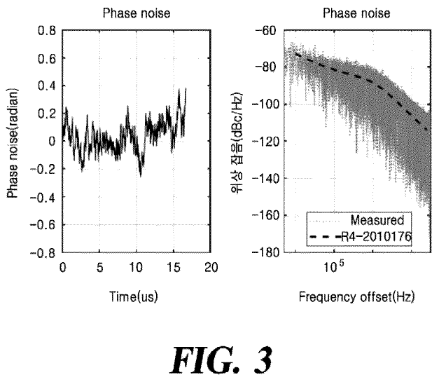

FIG. 3 is an example diagram showing phase noise time response and frequency spectrum.

The phase noise typically exhibits a frequency power spectrum similar to that of a low-pass filter. Therefore, as shown in FIG. 3, based on the frequency offset of 0, only 2U+1 number of central components may be considered and the remaining components may be ignored. That is, only components from \tilde{p}_{-U,l}^{ft} to \tilde{p}_{U,l}^{ft} in the frequency power spectrum of the residual phase noise are considered.

Considering only 2U+1 number of central components among the frequency components of the phase noise, a single received symbol with compensated channel can be expressed as Equation 6.

$$\text{?} \qquad ( Equation 6 )$$

$$\text{?} \text{indicates text missing or illegible when filed}$$

In Equation 6, q_{m,l}^{f} and h_{m,l′}^{f} and represent the m-th diagonal components of Q_{M,l}^{f} and H_{M,l′}^{f} diagonal matrices, respectively. If the channel component h_{m,l′}^{f} is completely removed by the channel equalization component h_{m,l′}^{f}, the phase noise of the received symbol after channel equalization can be expressed by \tilde{p}_{0,l′}^{f} which is CPE component unrelated to the subcarrier index and other ICIs, as follows.

$${\hat{x}}_{m , l}^{ft} = \text{?} + {\sum }_{\begin{matrix}u = - U \\ u \neq 0\end{matrix}}^{U} ( {q}_{m , l}^{f} \text{?} ) \qquad ( Equation 7 )$$

$$\text{?} \text{indicates text missing or illegible when filed}$$

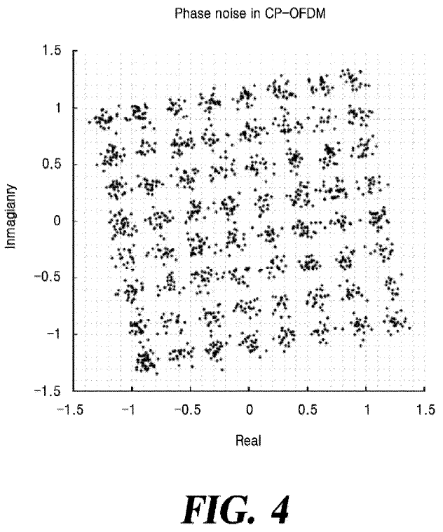

FIG. 4 is a constellation diagram of a received signal distorted by phase noise.

If Equation 7 is plotted as a constellation, it can be seen that the entire constellation is rotated as much as CPE component, and the magnitude and phase are distorted by the ICI component, so the points of the constellation are spread out, as shown in FIG. 4.

For the CPE component, the CPE component can be eliminated by placing a plurality of reference signals for phase noise estimation in an OFDM symbol, extracting the phase noise component they have in common, and then compensating for all subcarriers in the OFDM symbol. For the ICI component, one approach is to design the OFDM symbol with large subcarrier interval to prevent ICI from occurring from the beginning. In this case, most of the effects of phase noise can be eliminated by only compensating for the CPE. However, when the subcarrier interval cannot be increased, a scheme of estimating the frequency response of the phase noise using various methods and then compensating for the ICI of the phase noise based on this is mainly considered. As a technique that can estimate ICI, there is a scheme of estimating the frequency response of the phase noise by grouping several adjacent subcarriers and using them as a reference signal, and then compensating for the ICI. In this case, subcarriers corresponding to a wider frequency range than the frequency spectrum of the actual phase noise can be allocated to phase noise estimation as follows.

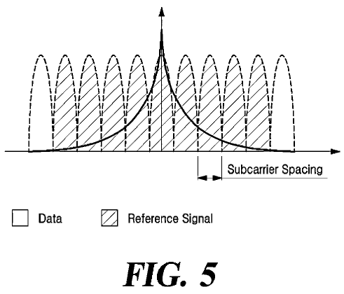

FIG. 5 is an example diagram of reference signal allocation for phase noise estimation.

When a reference signal for phase noise estimation is allocated as shown in FIG. 5, the following equation can be constructed.

$$[ \begin{matrix}\text{?} \\ \text{?} \\ \text{?} \\ ⋮ \\ \text{?} \\ \text{?}\end{matrix} ] = [ \begin{matrix}\text{?} & \text{?} & \text{?} & ⋱ & \text{?} & \text{?} \\ \text{?} & \text{?} & \text{?} & ⋱ & \text{?} & \text{?} \\ \text{?} & \text{?} & \text{?} & ⋱ & \text{?} & \text{?} \\ ⋱ & ⋱ & ⋱ & ⋱ & ⋱ & ⋱ \\ \text{?} & \text{?} & \text{?} & ⋱ & \text{?} & \text{?} \\ \text{?} & \text{?} & \text{?} & ⋱ & \text{?} & \text{?}\end{matrix} ] [ \begin{matrix}\text{?} \\ \text{?} \\ \text{?} \\ ⋮ \\ \text{?} \\ \text{?}\end{matrix} ] + [ \begin{matrix}\text{?} \\ \text{?} \\ \text{?} \\ ⋮ \\ \text{?} \\ \text{?}\end{matrix} ] \qquad ( Equation 8 )$$

$$\text{?} \text{indicates text missing or illegible when filed}$$

In Equation 8, {Xₙ₊ᵤ|−2U≤u≤2U} is the reference signal for phase noise estimation, and {Jᵤ|−U≤u≤U} is the frequency response of the phase noise to be estimated. Further, {Rₙ₋ᵤ^{eq}|−U≤u≤U} is the received signal, and {Qₙ₋ᵤ^{eq}|−U≤u≤U} is interference by phase noise that exists outside the frequency offset range of the phase noise to be estimated, which is a value that is almost negligible.

Another technique that can estimate ICI is to directly estimate the ICI removal filter (de-ICI filter) that removes ICI due to phase noise, wherein there is no limit to the location of the subcarrier of the phase noise reference signal, and the subcarrier allocated to general data corresponding to as much of the frequency range as the frequency spectrum of the phase noise to be estimated needs to be used.

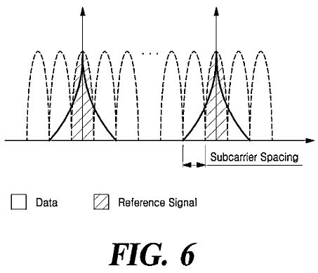

FIG. 6 is an example diagram of allocating a reference signal for phase noise estimation.

Using the reference signal allocation as shown in FIG. 6, a filter for removing interference between subcarriers of the OFDM modulation/demodulation scheme due to phase noise can be expressed as Equation 9.

$${R}_{k}^{eq} = {\sum }_{n = 0}^{N - 1} ( {X}_{n} {J}_{k - n} ) \qquad ( Equation 9 )$$

$$\text{?} ( {a}_{m} {R}_{k - m}^{eq} ) \approx {X}_{k} ,$$

$$for$$

$$k ∈ \{ {k}_{0} , {k}_{1} , … , {k}_{K - 1} \}$$

$$\text{?} \text{indicates text missing or illegible when filed}$$

In Equation 9, Xₖ is the reference signal for phase noise estimation, and αₘ is the ICI removal filter with 2U+1 number of taps. The tap of the ICI removal filter can be obtained as shown in Equation 10.

$$\text{?} = \text{?} ‖ [ \begin{matrix}\text{?} & … & \text{?} \\ ⋮ & ⋱ & ⋮ \\ \text{?} & ⋯ & \text{?}\end{matrix} ] [ \begin{matrix}\text{?} \\ ⋮ \\ \text{?}\end{matrix} ] - [ \begin{matrix}\text{?} \\ ⋮ \\ \text{?}\end{matrix} ] \text{?} = \text{?} \qquad ( Equation 10 )$$

$$\text{?} = \text{?}$$

$$\text{?} \text{indicates text missing or illegible when filed}$$

Techniques for removing ICI are to estimate the frequency spectrum of the phase noise after channel estimation and equalization are accurately performed. If the channel estimation is not performed properly, the reliability of the estimated frequency spectrum of the phase noise is lowered. Embodiments of the present disclosure propose a reference signal design scheme for increasing the reliability of estimation of the frequency spectrum of phase noise by reducing channel estimation error when using the OFDM modulation scheme in a multiple transmission/reception point environment.

In the OFDM modulation scheme, the frequency spectrum of the phase noise is estimated to compensate for the ICI caused by the phase noise. In order to increase the reliability of the estimation of the frequency spectrum of the phase noise in a multi-transmission/reception environment, it is important to reduce the channel estimation error as much as possible, and to ensure that the received symbols used in the phase noise estimation are subjected to the same environment as much as possible. By analyzing the symbols used in the estimation of phase noise for various multiple transmission/reception point scenarios, it is possible to check whether all symbols are subjected to the same environment.

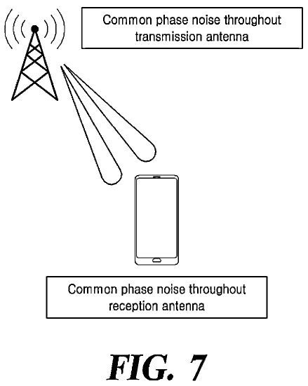

FIG. 7 is an example diagram of a single transmission/reception point multiple antenna environment.

First, the case of using multiple antennas in a single transmission/reception point environment, as shown in FIG. 7, can be considered.

In the single transmission/reception point multiple antenna environment as shown in FIG. 7, a rank 2 transmission system model with two transmission beams and two antennas of a receiving terminal can be expressed as Equation 11.

$$( Equation 11 )$$

$${y}_{1}^{( DMRS )} = {P}_{R}^{( DMRS )} ( {H}_{( 1 , A 1 )} {P}_{A}^{( DMRS )} {x}_{A 1}^{( DMRS )} + {H}_{( 1 , A 2 )} {P}_{A}^{( DMRS )} {x}_{A 2}^{( DMRS )}$$

$${y}_{2}^{( DMRS )} = {P}_{R}^{( DMRS )} ( {H}_{( 2 , A 1 )} {P}_{A}^{( DMRS )} {x}_{A 1}^{( DMRS )} + {H}_{( 2 , A 2 )} {P}_{A}^{( DMRS )} {x}_{A 2}^{( DMRS )}$$

$${y}^{( DMRS )} = [ \begin{matrix}{y}_{1}^{( DMRS )} \\ {y}_{2}^{( DMRS )}\end{matrix} ] = [ \begin{matrix}{P}_{R}^{( DMRS )} & {0}_{N} \\ {0}_{N} & {P}_{R}^{( DMRS )}\end{matrix} ] [ \begin{matrix}{H}_{( 1 , A 1 )} & {H}_{( 1 , A 2 )} \\ {H}_{( 2 , A 1 )} & {H}_{( 2 , A 2 )}\end{matrix} ] [ \text{} \begin{matrix}{P}_{A}^{( DMRS )} & {0}_{N} \\ {0}_{N} & {P}_{A}^{( DMRS )}\end{matrix} ] [ \begin{matrix}{x}_{A 1}^{( DMRS )} \\ {x}_{A 2}^{( DMRS )}\end{matrix} ]$$

In Equation 11, y₁^{(DMRS)} is a frequency domain OFDM symbol including a channel estimation reference signal received from the first antenna of the receiving terminal, and y₂^{(DMRS)} is a frequency domain OFDM symbol including a channel estimation reference signal received from the second antenna of the receiving terminal. x_{A1}^{(DMRS)} is a frequency domain OFDM symbol including a channel estimation reference signal transmitted through the first beam of transmitter A, and x_{A2}^{(DMRS)} is a frequency domain OFDM symbol including a channel estimation reference signal transmitted through the second beam of transmitter A. H_{(1,A1)}, H_{(1,A2)}, H_{(2,A1)}, H_{(2,A2)} denote the channel between the first beam of transmitter A and the first antenna of the terminal, the channel between the second beam of transmitter A and the first antenna of the terminal, the channel between the first beam of transmitter A and the second antenna of the terminal, and the channel between the first beam of transmitter A and the second antenna of the terminal, respectively. P_{A}^{(DMRS)} is the phase noise matrix applied by transmitter A to the frequency domain transmission OFDM symbol including the channel estimation reference signal, and P_{R}^{(DMRS)} is the phase noise matrix applied by the terminal to the frequency domain reception OFDM symbol including the channel estimation reference signal. For the OFDM symbol including a channel estimation reference signal, the effective channel estimate, which is the result of estimating the channel with phase noise, is obtained by Equation 12

$$( Equation 12 )$$

$$\hat{H} = [ \begin{matrix}{P}_{R}^{( DMRS )} & {0}_{N} \\ {0}_{N} & {P}_{R}^{( DMRS )}\end{matrix} ] [ \begin{matrix}{H}_{( 1 , A 1 )} & {H}_{( 1 , A 2 )} \\ {H}_{( 2 , A 1 )} & {H}_{( 2 , A 2 )}\end{matrix} ] [ \text{} \begin{matrix}{P}_{A}^{( DMRS )} & {0}_{N} \\ {0}_{N} & {P}_{A}^{( DMRS )}\end{matrix} ]$$

By performing channel equalization of an OFDM symbol including no channel estimation reference signal using the effective channel estimate value estimated from an OFDM symbol including a channel estimation reference signal, an estimate value of the transmission OFDM symbol can be obtained as shown in Equation 13.

$$( Equation 13 )$$

$${y}^{( data )} = [ \text{} \begin{matrix}{y}_{1}^{( data )} \\ {y}_{2}^{( data )}\end{matrix} ] = [ \begin{matrix}{P}_{R}^{( data )} & {0}_{N} \\ {0}_{N} & {P}_{R}^{( data )}\end{matrix} ] [ \begin{matrix}{H}_{( 1 , A 1 )} & {H}_{( 1 , A 2 )} \\ {H}_{( 2 , A 1 )} & {H}_{( 2 , A 2 )}\end{matrix} ] [ \begin{matrix}{P}_{A}^{( data )} & {0}_{N} \\ {0}_{N} & {P}_{A}^{( data )}\end{matrix} ] [ \begin{matrix}{x}_{A 1}^{( data )} \\ {x}_{A 2}^{( data )}\end{matrix} ]$$

$$\text{?} = {( \hat{H} )}^{- 1} {y}^{( data )} = {{[ \begin{matrix}{P}_{A}^{( data )} & {0}_{N} \\ {0}_{N} & {P}_{A}^{( data )}\end{matrix} ]}^{- 1} [ \begin{matrix}{H}_{( 1 , A 1 )} & {H}_{( 1 , A 2 )} \\ {H}_{( 2 , A 1 )} & {H}_{( 2 , A 2 )}\end{matrix} ]}^{- 1} {[ \begin{matrix}{P}_{R}^{( DMRS )} & {0}_{N} \\ {0}_{N} & {P}_{R}^{( DMRS )}\end{matrix} ]}^{- 1} {y}^{( data )} = {{{[ \text{} \begin{matrix}{P}_{A}^{( DMRS )} & {0}_{N} \\ {0}_{N} & {P}_{A}^{( DMRS )}\end{matrix} ]}^{- 1} [ \begin{matrix}{H}_{( 1 , A 1 )} & {H}_{( 1 , A 2 )} \\ {H}_{( 2 , A 1 )} & {H}_{( 2 , A 2 )}\end{matrix} ]}^{- 1} [ \begin{matrix}{P}_{R}^{( DMRS )} & {0}_{N} \\ {0}_{N} & {P}_{R}^{( DMRS )}\end{matrix} ]}^{- 1} \text{?} [ \begin{matrix}{P}_{R}^{( data )} & {0}_{N} \\ {0}_{N} & {P}_{R}^{( data )}\end{matrix} ] [ \begin{matrix}{H}_{( 1 , A 1 )} & {H}_{( 1 , A 2 )} \\ {H}_{( 2 , A 1 )} & {H}_{( 2 , A 2 )}\end{matrix} ] [ \begin{matrix}{P}_{A}^{( data )} & {0}_{N} \\ {0}_{N} & {P}_{A}^{( data )}\end{matrix} ] [ \begin{matrix}{x}_{A 1}^{( data )} \\ {x}_{A 2}^{( data )}\end{matrix} ]$$

$$\text{?} \text{indicates text missing or illegible when filed}$$

In Equation 13, the channel matrix and the channel equalization matrix are matrices of the form shown in Equation 14.

$${H}_{( a , b )} = diag ( {h}_{( a , b ) , 0} , {h}_{( a , b ) , 1} , … , {h}_{( a , b ) , n} , … {h}_{( , b ) , 2 N - 1} ) \qquad ( Equation 14 )$$

$$G = {H}^{- 1} = {[ \begin{matrix}{H}_{( 1 , A 1 )} & {H}_{( 1 , A 2 )} \\ {H}_{( 2 , A 1 )} & {H}_{( 2 , A 2 )}\end{matrix} ]}^{- 1} = [ \begin{matrix}{G}_{( 1 , A 1 )} & {G}_{( 1 , A 2 )} \\ {G}_{( 2 , A 1 )} & {G}_{( 2 , A 2 )}\end{matrix} ]$$

$${G}_{( a , b )} = diag ( {g}_{( a , b ) , 0} , {g}_{( a , b ) , 1} , … , {g}_{( a , b ) , n} , … {g}_{( , b ) , 2 N - 1} )$$

The channel matrix and th channel equalization matrix have the form of diagonal matrices as shown in Equation 14, assuming that the channel rarely changes within one symbol. In addition, under the assumption that the channel is maintained until the next OFDM symbol including the channel estimation reference signal, the channel value of the OFDM symbol including the channel estimation reference signal and the channel value of the OFDM symbol including no channel estimation reference signal can be considered to be the same. Further, the phase noise matrix of transmitter A can be expressed as Equation 15.

$$\text{?} \qquad ( Equation 15 )$$

$$\text{?}$$

$$\text{?}$$

$$\text{?} \text{indicates text missing or illegible when filed}$$

Unlike the channel, the phase noise changes for every symbol, so P_{A}^{(DMRS)} and P_{A}^{(data)}. A in Equation 15 have different values. As shown in Equation 15, the inverse matrix of the block diagonal matrix has the form of a diagonal matrix with the inverse matrix of each block as a block, and each block of the phase noise matrix and its inverse matrix all have the form of a cyclic matrix. Further, the residual phase noise matrix remaining after the phase noise of the terminal is compensated for each other by the effective channel estimate is defined as Equation 16.

$$[ \begin{matrix}{\tilde{P}}_{A}^{( data )} & {0}_{N} \\ {0}_{N} & {\tilde{P}}_{A}^{( data )}\end{matrix} ] = {[ \begin{matrix}{P}_{R}^{( DMRS )} & {0}_{N} \\ {0}_{N} & {P}_{R}^{( DMRS )}\end{matrix} ]}^{- 1} [ \begin{matrix}{P}_{R}^{( data )} & {0}_{N} \\ {0}_{N} & {P}_{R}^{( data )}\end{matrix} ] \qquad ( Equation 15 )$$

$${\tilde{P}}_{R}^{( data )} = [ \begin{matrix}{\tilde{p}}_{R , 0}^{( data )} & {\tilde{p}}_{R , 1}^{( data )} & ⋰ & \text{?} & 0 & ⋰ \\ {\tilde{p}}_{R , - 1}^{( data )} & {\tilde{p}}_{R , 0}^{( data )} & {\tilde{p}}_{A , 1}^{( data )} & ⋰ & \text{?} & 0 \\ ⋰ & {\tilde{p}}_{R , - 1}^{( data )} & {\tilde{p}}_{A , 0}^{( data )} & {\tilde{p}}_{A , 1}^{( data )} & ⋰ & \text{?} \\ \text{?} & ⋰ & {\tilde{p}}_{A , - 1}^{( data )} & {\tilde{p}}_{A , 0}^{( data )} & {\tilde{p}}_{A , 1}^{( data )} & ⋰ \\ 0 & \text{?} & ⋰ & {\tilde{p}}_{A , - 1}^{( data )} & {\tilde{p}}_{A , 0}^{( data )} & {\tilde{p}}_{A , 1}^{( data )} \\ ⋰ & 0 & \text{?} & ⋰ & {\tilde{p}}_{A , - 1}^{( data )} & {\tilde{p}}_{A , 0}^{( data )}\end{matrix} ]$$

$$\text{?} \text{indicates text missing or illegible when filed}$$

As shown in Equation 16, the residual phase noise matrix also has a cyclic matrix form in the frequency domain. For convenience, a new matrix that considers only the phase noise matrices of the remaining channels and the receiving terminal, excluding the effect of the phase noise caused by transmitter A, is defined as Equation 17.

$$( Equation 17 )$$

$$V = [ \begin{matrix}\text{?} & \text{?} \\ \text{?} & \text{?}\end{matrix} ] = G [ \text{} \begin{matrix}{\tilde{P}}_{R}^{( data )} & {0}_{N} \\ {0}_{N} & {\tilde{P}}_{R}^{( data )}\end{matrix} ] H = [ \begin{matrix}{G}_{( 1 , A 1 )} & {G}_{( 1 , A 2 )} \\ {G}_{( 2 , A 1 )} & {G}_{( 2 , A 2 )}\end{matrix} ] [ \text{} \begin{matrix}{\tilde{P}}_{R}^{( data )} & {0}_{N} \\ {0}_{N} & {\tilde{P}}_{R}^{( data )}\end{matrix} ] [ \text{} \begin{matrix}{H}_{( 1 , A 1 )} & {H}_{( 1 , A 2 )} \\ {H}_{( 2 , A 1 )} & {H}_{( 2 , A 2 )}\end{matrix} ] = [ \begin{matrix}{G}_{( 1 , A 1 )} {\tilde{P}}_{R}^{( data )} {H}_{( 1 , A 1 )} + {G}_{( 1 , A 1 )} {\tilde{P}}_{R}^{( data )} \text{?} & {G}_{( 1 , A 1 )} {\tilde{P}}_{R}^{( data )} \text{?} + {G}_{( 1 , A 1 )} {\tilde{P}}_{R}^{( data )} \text{?} \\ {G}_{( 2 , A 1 )} {\tilde{P}}_{R}^{( data )} {H}_{( 1 , A 1 )} + {G}_{( 2 , A 1 )} {\tilde{P}}_{R}^{( data )} \text{?} & {G}_{( 2 , A 1 )} {\tilde{P}}_{R}^{( data )} \text{?} + {G}_{( 2 , A 1 )} {\tilde{P}}_{R}^{( data )} \text{?}\end{matrix} ]$$

$$\text{?} \text{indicates text missing or illegible when filed}$$

In Equation 17, each block matrix constituting the v matrix has the form as shown in Equation 18.

$$\text{?} = [ \begin{matrix}\text{?} & \text{?} & ⋱ & \text{?} & 0 & ⋱ \\ \text{?} & \text{?} & ⋱ & \text{?} & \text{?} & ⋱ \\ ⋱ & ⋱ & ⋱ & ⋱ & ⋱ & ⋱ \\ \text{?} & \text{?} & ⋱ & \text{?} & \text{?} & ⋱ \\ 0 & \text{?} & ⋱ & \text{?} & \text{?} & ⋱ \\ ⋱ & ⋱ & ⋱ & ⋱ & ⋱ & ⋱\end{matrix} ] \qquad ( Equation 18 ]$$

$$\text{?} \text{indicates text missing or illegible when filed}$$

The estimate value of the transmission OFDM symbol including the matrix can be expressed as Equation 19.

$${\hat{x}}^{( data )} [ \begin{matrix}{( {Q}_{A}^{( DMRS )} )}^{T} & {0}_{N} \\ {0}_{N} & {( {Q}_{A}^{( DMRS )} )}^{T}\end{matrix} ] V [ \begin{matrix}{P}_{A}^{( data )} & {0}_{N} \\ {0}_{N} & {P}_{A}^{( data )}\end{matrix} ] [ \begin{matrix}{x}_{A 1}^{( data )} \\ {x}_{A 2}^{( data )}\end{matrix} ] \qquad ( Equation 19 )$$

In Equation 19, the equation for the symbol vector transmitted through the first beam of transmitter A among the estimate values of the transmission OFDM symbol vector is summarized as Equation 20.

$$( Equation 20 )$$

$${x}_{A 1}^{( data )} = {\underbrace{{( {Q}_{A}^{( DMRS )} )}^{T} {V}_{11} {P}_{A}^{( data )} {x}_{A 1}^{( data )}}}_{intra - layer interference} + {\underbrace{{( {Q}_{A}^{( DMRS )} )}^{T} {V}_{12} {P}_{A}^{( data )} {x}_{A 2}^{( data )}}}_{inter - layer interference}$$

The transmission symbol vector estimation equation in Equation 20 can be divided into two parts, the intra-layer interference component and the inter-layer interference component. First, the intra-layer interference component can be summarized as Equation 21.

$$\text{?} = \text{?} = [ \begin{matrix}\text{?} \\ \text{?} \\ ⋮ \\ \text{?} \\ ⋮ \\ \text{?}\end{matrix} ] \text{?} = [ \begin{matrix}\text{?} & \text{?} & … & \text{?} & … & \text{?} \\ \text{?} & \text{?} & … & \text{?} & … & \text{?} \\ ⋮ & ⋮ & ⋱ & ⋮ & ⋱ & ⋮ \\ \text{?} & \text{?} & … & \text{?} & … & \text{?} \\ ⋮ & ⋮ & ⋱ & ⋮ & ⋱ & ⋮ \\ \text{?} & \text{?} & … & \text{?} & … & \text{?}\end{matrix} ] \text{?} \qquad ( Equation 21 )$$

$$\text{?} \text{indicates text missing or illegible when filed}$$

The transposed row vector of the column vector value of Q_{A}^{(DMRS)} corresponding to the inverse matrix of the phase noise matrix of transmitter A in Equation 21 is as shown in Equation 22.

$$( Equation 22 )$$

$${( {q}_{A , n + i}^{( data )} )}^{T} = [ \begin{matrix}… & {q}_{A , - i + 2}^{( DRMS )} & {q}_{A , - i + 1}^{( DMRS )} & {\underbrace{{q}_{A , - i}^{( DMRS )}}}_{n - th element} & {q}_{A , - i - 1}^{( DMRS )} & {q}_{A , - i - 2}^{( DMRS )} & …\end{matrix} ]$$

In the transposed row vector formula of the column vector of the Q_{A}^{(DMRS)} matrix, i represents the magnitude of the offset based on the index n, and is {i|−n≤i≤N−n−1}. Further, among the intra-layer interference components of the transmission symbol vector estimation equation, each column vector of the V₁₁ matrix has the form shown in Equation 23.

$$\text{?} = [ \begin{matrix}⋮ \\ \text{?} \\ \text{?} \\ \text{?} \\ \text{?} \\ \text{?} \\ ⋮\end{matrix} ] = [ \begin{matrix}⋮ \\ \text{?} \\ \text{?} \\ \text{?} \\ \text{?} \\ \text{?} \\ ⋮\end{matrix} ] \qquad ( Equation 23 )$$

$$\text{?} \text{indicates text missing or illegible when filed}$$

In the column vector equation of the V₁₁ matrix in Equation 23, i represents the magnitude of the offset based on the index n, and is {i|−n≤i≤N−n−1}.

Since the phase noise inverse matrix Q_{A}^{(DMRS)} and V₁₁ matrix both have valid values for only 2U+1 number of components centered on the diagonal component, the product of the row vector of Q_{A}^{(DMRS)} and the column vector of the V₁₁ matrix has a scalar value as in Equation 24.

$$\text{?} = \text{?} + \text{?} \qquad ( Equation 24 )$$

$$\text{?} \text{indicates text missing or illegible when filed}$$

The scalar value in Equation 24 changes depending on the indices i and j. Further, the phase noise matrix p_{A}^{(data)} of transmitter A can be expressed as a combination of column vectors as shown in Equation 25.

$${P}_{A}^{( data )} = [ {P}_{A , 0}^{( data )} , {P}_{A , 1}^{( data )} , … , {P}_{A , n}^{( data )} , … , {P}_{A , N - 1}^{( data )} ] \qquad ( Equation 25 )$$

$${P}_{A , n + k}^{( data )} = [ \begin{matrix}⋮ \\ {p}_{A , k}^{( data )} \\ ⋮ \\ {p}_{A , 1}^{( data )} \\ {p}_{A , 0}^{( data )} \\ {p}_{A , - 1}^{( data )} \\ ⋮\end{matrix} ]$$

In the column vector of Equation 25, p_{A,k}^{(data)} is the n-th component, and p_{A,1}^{(data)}, p_{A,0}^{(data)}, p_{A,-1}^{(data)} are the (n+k−1)-th, (n+k)-th, and (n+k+1)-th components, respectively. Since the phase noise matrix also has valid P_{A}^{(data)} also has valid values only for 2U+1 number of components centered on the diagonal component, using this, the intra-layer interference component part of the transmission OFDM symbol vector estimation equation can be summarized as Equation 26.

$$\text{?} = [ \begin{matrix}\text{?} & \text{?} & … & … & \text{?} \\ \text{?} & \text{?} & … & … & \text{?} \\ ⋮ & ⋮ & ⋱ & ⋱ & ⋮ \\ \text{?} & \text{?} & … & … & \text{?}\end{matrix} ] \text{?} \qquad ( Equation 26 )$$

$$\text{?} \text{indicates text missing or illegible when filed}$$

In Equation 26, if only the single symbol estimate value among the OFDM symbol vector estimation equations is summarized by considering the effective component of the column vector of P_{A}^{(data)}, it can be expressed as Equation 27.

$$\text{?} \qquad ( Equation 27 )$$

$$\text{?} \text{indicates text missing or illegible when filed}$$

The expression in Equation 27 is a general expression for the −n≤i≤N−n−1 range, and when summarized for i=0, it is equivalent to Equation 28.

$$\text{?} \qquad ( Equation 28 )$$

$$\text{?} \text{indicates text missing or illegible when filed}$$

In Equation 28, if the distortion (k=O) caused by own signals is considered as intra-carrier interference and the distortion (k≠O) caused by surrounding signals is considered as inter-carrier interference, as in Equations 29 and 30, the intra-layer component can also be separated into the inter-carrier component and the intra-carrier component.

$${\hat{x}}_{A 1 , n}^{( data )} {\vert}_{intra - layer} = {\hat{x}}_{A 1 , n}^{( data )} {\vert}_{\begin{matrix}intra - layer \\ intra - carrier\end{matrix}} + {\hat{x}}_{A 1 , n}^{( data )} {\vert}_{\begin{matrix}intra - layer \\ inter - carrier\end{matrix}} \qquad ( Equation 29 )$$

$$\text{?} \qquad ( Equation 30 )$$

$$\text{?} \text{indicates text missing or illegible when filed}$$

Next, the inter-layer interference component can be organized similarly to the intra-layer interference component, as shown in Equation 31.

$$\text{?} = [ \begin{matrix}\text{?} & \text{?} & … & … & \text{?} \\ \text{?} & \text{?} & … & … & \text{?} \\ ⋮ & ⋮ & ⋱ & ⋱ & ⋮ \\ \text{?} & \text{?} & … & … & \text{?}\end{matrix} ] \text{?} \qquad ( Equation 31 )$$

$$\text{?} \text{indicates text missing or illegible when filed}$$

Among the inter-layer interference components, each column vector of the V₁₂ matrix has the form shown in Equation 32.

$$\text{?} = [ \begin{matrix}⋮ \\ \text{?} \\ \text{?} \\ \text{?} \\ \text{?} \\ \text{?} \\ ⋮\end{matrix} ] = [ \begin{matrix}⋮ \\ \text{?} \\ \text{?} \\ \text{?} \\ \text{?} \\ \text{?} \\ ⋮\end{matrix} ] \qquad ( Equation 32 )$$

$$\text{?} \text{indicates text missing or illegible when filed}$$

In addition, the product of the row vector Q_{A}^{(DMRS)} and the column vector of the V₁₁ matrix of the inter-layer interference component has a scalar value as shown in Equation 33.

$$\text{?} \qquad ( Equation 33 )$$

$$\text{?} \text{indicates text missing or illegible when filed}$$

Using this, the single symbol estimate value of the inter-layer interference component part of the transmission OFDM symbol vector estimation equation can be summarized as Equation 34.

$$\text{?} \qquad ( Equation 34 )$$

$$\text{?} \text{indicates text missing or illegible when filed}$$

The inter-layer interference component can also be separated into an intra-carrier component, which is distortion (k=O) due to own signals, and an inter-carrier interference component, which is distortion (k≠O) due to surrounding signals, as shown in Equations 35 and 36.

$${\hat{x}}_{A 1 , n}^{( data )} {\vert}_{inter - layer} = {\hat{x}}_{A 1 , n}^{( data )} {\vert}_{\begin{matrix}inter - layer \\ intra - carrier\end{matrix}} + {\hat{x}}_{A 1 , n}^{( data )} {\vert}_{\begin{matrix}inter - layer \\ inter - carrier\end{matrix}} \qquad ( Equation 35 )$$

$$\text{?} \qquad ( Equation 36 )$$

$$\text{?} \text{indicates text missing or illegible when filed}$$

By adding the intra-layer and inter-layer interference components obtained from Equations 35 and 36, the single symbol estimate value of the transmission OFDM symbol vector is summarized as Equation 37.

$$\text{?} \qquad ( Equation 37 )$$

$$\text{?} \text{indicates text missing or illegible when filed}$$

In the single symbol estimate value of the transmission OFDM symbol vector obtained from Equation 37, if there is no ICI of phase noise, that is if U=0, Equation 37 is simplified as Equation 38.

[symbol]

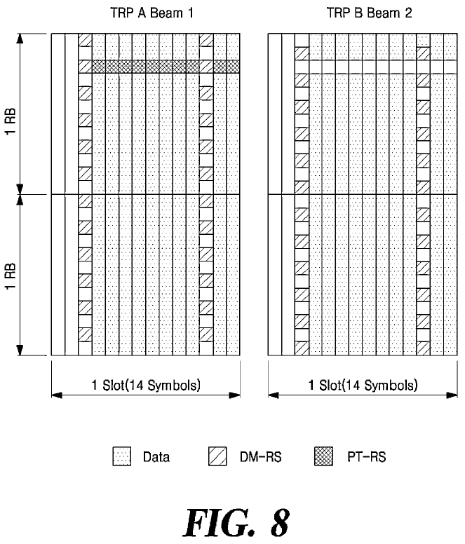

As shown in Equation 38, when U=0, that is, when the effective bandwidth of phase noise is less than the subcarrier interval, and the channel estimation is perfect, the inter-layer interference component also disappears, and the inter-layer interference component of the intra-layer caused by phase noise also disappears. If the general information symbol is transmitted through both the first and second beams of transmitter A, and the reference signal for phase noise estimation is transmitted through either the first or second beam of transmitter A to prevent deterioration of phase noise estimation performance due to the inter-layer interference, the symbol mapping is as shown in the following FIG. 8.

FIG. 8 is an example of symbol allocation in the OFDM system in the single transmission/reception point multiple antenna environment.

In the environment as shown in FIG. 8, when the receiving terminal estimates the reference signal for phase noise estimation, the estimate value satisfies Equation 39

$$\text{?} = \{ \begin{matrix}\text{?} & U > 0 \\ \text{?} & U = 0\end{matrix} \qquad ( Equation 39 )$$

$$\text{?} \text{indicates text missing or illegible when filed}$$

In Equation 39, when U=0, that is, when only the CPE component due to phase noise is estimated, all inter-layer components are ignored, and among the intra-layer components, the inter-carrier component is also assumed to be 0, so that the reference signal estimate value in the case of U=0 estimates only the intra-carrier component of the intra-layer, that is, the CPE value. In this case, there is no problem even if the phase noise is estimated through the mapping as shown in FIG. 8. Rather, it can be considered as a mapping capable of improving the reliability of phase noise estimation by reducing inter-layer interference components that may occur due to channel estimation errors by any chance.

However, the situation changes when U>0, that is, when estimating not only the CPE component due to phase noise, but also the entire frequency spectrum of phase noise affecting surrounding subcarriers. When the reference signal is located at index n, the intra-carrier component of the inter-layer becomes 0 because the reference signal is transmitted through one beam and not through the other beam, but the remaining intra-carrier component of the inter-layer and the inter-carrier component of the intra-layer are all taken into account to estimate the phase noise. As previously described in the scheme for estimating and compensating for the ICI of phase noise, to estimate the entire frequency spectrum of phase noise, not only the OFDM symbol to which the reference signal is mapped but also surrounding general information symbols may be used. However, there is a difference between the estimate value of the received symbol at the location where the reference signal is mapped and the estimate value of the received symbol around the reference signal, as shown in Equation 40.

$$\text{?} \qquad ( Equation 40 )$$

$$\text{?}$$

$$\text{?} \text{indicates text missing or illegible when filed}$$

As shown in Equation 40, the received symbols used in estimating ICI due to phase noise do not go through the same environment and have differences in presence or absence depending on reference signal mapping.

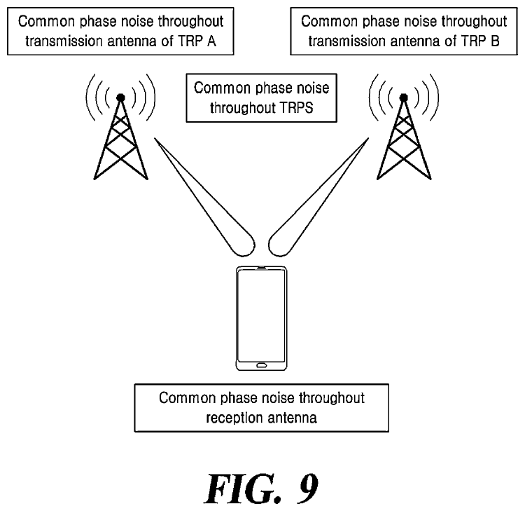

FIG. 9 is an example diagram of a multiple transmission/reception point environment with a single antenna.

As shown in FIG. 9, it can be considered when using multiple antennas in a multiple transmission/reception point environment.

In the multiple transmission/reception point single antenna environment as shown in FIG. 9, a rank 2 transmission system model with one transmission beam and two antennas of the receiving terminal can be expressed as Equations 41 and 42.

$$( Equation 41 )$$

$${y}_{1}^{( DMRS )} = {P}_{R}^{( DMRS )} ( {H}_{( 1 , A 1 )} {P}_{A}^{( DMRS )} {x}_{A 1}^{( DMRS )} + {H}_{( 1 , B 1 )} {P}_{B}^{( DMRS )} {x}_{B 1}^{( DMRS )} )$$

$${y}_{2}^{( DMRS )} = {P}_{R}^{( DMRS )} ( {H}_{( 2 , A 1 )} {P}_{A}^{( DMRS )} {x}_{A 1}^{( DMRS )} + {H}_{( 2 , B 1 )} {P}_{B}^{( DMRS )} {x}_{B 1}^{( DMRS )} )$$

$$( Equation 42 )$$

$${y}^{( DMRS )} = [ \text{} \begin{matrix}{y}_{1}^{( DMRS )} \\ {y}_{2}^{( DMRS )}\end{matrix} ] = [ \begin{matrix}{P}_{R}^{( DMRS )} & {0}_{N} \\ {0}_{N} & {P}_{R}^{( DMRS )}\end{matrix} ] [ \begin{matrix}{H}_{( 1 , A 1 )} & {H}_{( 1 , B 1 )} \\ {H}_{( 2 , A 1 )} & {H}_{( 2 , B 1 )}\end{matrix} ] [ \text{} \begin{matrix}{P}_{A}^{( DMRS )} & {0}_{N} \\ {0}_{N} & {P}_{B}^{( DMRS )}\end{matrix} ] [ \begin{matrix}{x}_{A 1}^{( DMRS )} \\ {x}_{B 1}^{( DMRS )}\end{matrix} ]$$

In Equation 42, y₁^{(DMRS)} and y₂^{(DMRS)} are frequency domain OFDM symbols including channel estimation reference signals received from the first and second antennas of the receiving terminal, respectively, x_{A1}^{(DMRS)} and x_{B1}^{(DMRS)} are frequency domain OFDM symbols including channel estimation reference signals transmitted by transmitter A and transmitter B, respectively. H_{(1,A1)}, H_{(1,B1)}, H_{(2,A1)}, and H_{(2,B1)} denote the channels between transmitter A and the first antenna of the terminal, and the channels between transmitter B and the first antenna of the terminal, the channel between transmitter A and the second antenna of the terminal, and the channel between transmitter B and the second antenna of the terminal, respectively. P_{A}^{(DMRS)} and P_{B}^{(DMRS)} are the phase noise matrices applied by transmitter A and transmitter B to the frequency domain transmission OFDM symbol including the channel estimation reference signal, respectively, and P_{R}^{(DMRS)} is the phase noise matrix applied by the terminal to the frequency domain reception OFDM symbol including the channel estimation reference signal. In the OFDM symbol including the channel estimation reference signal, the effective channel estimate value resulting from estimating the channel including phase noise satisfies Equation 43.

$$( Equation 43 )$$

$$\hat{H} = [ \begin{matrix}{P}_{R}^{( DMRS )} & {0}_{N} \\ {0}_{N} & {P}_{R}^{( DMRS )}\end{matrix} ] [ \begin{matrix}{H}_{( 1 , A 1 )} & {H}_{( 1 , B 1 )} \\ {H}_{( 2 , A 1 )} & {H}_{( 2 , B 1 )}\end{matrix} ] [ \text{} \begin{matrix}{P}_{A}^{( DMRS )} & {0}_{N} \\ {0}_{N} & {P}_{B}^{( DMRS )}\end{matrix} ]$$

In a manner similar to the single transmission/reception point multiple antenna environment, when channel equalization of an OFDM symbol including no channel estimate reference signal is performed using the effective channel estimate value estimated from an OFDM symbol including a channel estimate reference signal, an estimate of the transmitted OFDM symbol can be obtained as shown in Equation 44.

$$( Equation 44 )$$

$${y}^{( data )} = [ \text{} \begin{matrix}{y}_{1}^{( data )} \\ {y}_{2}^{( data )}\end{matrix} ] = [ \begin{matrix}{P}_{R}^{( data )} & {0}_{N} \\ {0}_{N} & {P}_{R}^{( data )}\end{matrix} ] [ \begin{matrix}{H}_{( 1 , A 1 )} & {H}_{( 1 , B 1 )} \\ {H}_{( 2 , A 1 )} & {H}_{( 2 , B 1 )}\end{matrix} ] [ \begin{matrix}{P}_{A}^{( data )} & {0}_{N} \\ {0}_{N} & {P}_{B}^{( data )}\end{matrix} ] [ \begin{matrix}{x}_{A 1}^{( data )} \\ {x}_{B 1}^{( data )}\end{matrix} ]$$

$${\hat{x}}^{( data )} = {( \hat{H} )}^{- 1} {y}^{( data )} = {{{[ \begin{matrix}{P}_{A}^{( DMRS )} & {0}_{N} \\ {0}_{N} & {P}_{B}^{( DMRS )}\end{matrix} ]}^{- 1} [ \begin{matrix}{H}_{( 1 , A 1 )} & {H}_{( 1 , B 1 )} \\ {H}_{( 2 , A 1 )} & {H}_{( 2 , B 1 )}\end{matrix} ]}^{- 1} [ \begin{matrix}{P}_{R}^{( DMRS )} & {0}_{N} \\ {0}_{N} & {P}_{R}^{( DMRS )}\end{matrix} ]}^{- 1} \text{?} [ \begin{matrix}{P}_{R}^{( data )} & {0}_{N} \\ {0}_{N} & {P}_{R}^{( data )}\end{matrix} ] [ \begin{matrix}{H}_{( 1 , A 1 )} & {H}_{( 1 , B 1 )} \\ {H}_{( 2 , A 1 )} & {H}_{( 2 , B 1 )}\end{matrix} ] [ \begin{matrix}{P}_{A}^{( data )} & {0}_{N} \\ {0}_{N} & {P}_{B}^{( data )}\end{matrix} ] [ \begin{matrix}{x}_{A 1}^{( data )} \\ {x}_{B 1}^{( data )}\end{matrix} ]$$

$$\text{?} \text{indicates text missing or illegible when filed}$$

It is assumed that the channel matrix and channel equalization matrix have the form of a diagonal matrix like the single transmission/reception point multi-antenna environment, and that the channel value of the OFDM symbol including the channel estimation reference signal and the channel value of the OFDM symbol including no channel estimation reference signal are the same. Further, the phase noise matrices of transmitter A and transmitter B can be expressed as Equation 45.

$${[ \begin{matrix}{P}_{A}^{( DMRS )} & {0}_{N} \\ {0}_{N} & {P}_{B}^{( DMRS )}\end{matrix} ]}^{- 1} = [ \text{} \begin{matrix}{( {P}_{A}^{( DMRS )} )}^{- 1} & {0}_{N} \\ {0}_{N} & {( {P}_{B}^{( DMRS )} )}^{- 1}\end{matrix} ] = [ \text{} \begin{matrix}{( {Q}_{A}^{( DMRS )} )}^{T} & {0}_{N} \\ {0}_{N} & {( {Q}_{B}^{( DMRS )} )}^{T}\end{matrix} ] \qquad ( Equation 45 )$$

(P_{B}^{(DMRS)})⁻¹ and PB(data) are in the form of cyclic matrices such as (P_{A}^{(DMRS)})⁻¹ and P_{A}^{(data)} confirmed in the single transmission/reception point p(data) multi-antenna environment. Further, as assumed in the single transmission/reception point multi-antenna environment, phase noise changes for every symbol, so P_{A}^{(DMRS)} and P_{B}^{(DMRS)}, and P_{A}^{(data)} and P_{B}^{(data)} in Equation 45 have different values. In addition, since the phase noise of the terminal is compensated for by the effective channel estimate and the remaining residual phase noise matrix is the same as in the single transmission/reception point multiple antenna environment, it has a cyclic matrix form in the frequency domain. As in the single transmission/reception point multi-antenna environment, the matrix V, which considers only the phase noise matrices of the remaining channels and receiving terminals excluding the effects of phase noise caused by transmitter A and transmitter B, satisfies Equation 46.

$$( Equation 46 )$$

$$V [ \begin{matrix}{V}_{11} & {V}_{12} \\ {V}_{21} & \text{?}\end{matrix} ] = [ \begin{matrix}{G}_{( 1 , A 1 )} & {G}_{( 1 , B 1 )} \\ {G}_{( 2 , A 1 )} & {G}_{( 2 , B 1 )}\end{matrix} ] [ \begin{matrix}{\tilde{P}}_{R}^{( data )} & {0}_{N} \\ {0}_{N} & {\tilde{P}}_{R}^{( data )}\end{matrix} ] [ \begin{matrix}{H}_{( 1 , A 1 )} & {H}_{( 1 , B 1 )} \\ {H}_{( 2 , A 1 )} & {H}_{( 2 , B 1 )}\end{matrix} ] = [ \text{} \begin{matrix}{G}_{( 1 , A 1 )} {\tilde{P}}_{R}^{( data )} \text{?} + {G}_{( 1 , B 1 )} {\tilde{P}}_{R}^{( data )} {H}_{( 1 , A 1 )} & \text{?} {\tilde{P}}_{R}^{( data )} \text{?} + {G}_{( 1 , B 1 )} {\tilde{P}}_{R}^{( data )} \text{?} \\ {G}_{( 2 , A 1 )} {\tilde{P}}_{R}^{( data )} \text{?} + {G}_{( 2 , B 1 )} {\tilde{P}}_{R}^{( data )} {H}_{( 2 , A 1 )} & \text{?} {\tilde{P}}_{R}^{( data )} \text{?} + {G}_{( 2 , B 1 )} {\tilde{P}}_{R}^{( data )} \text{?}\end{matrix} ]$$

$$\text{?} \text{indicates text missing or illegible when filed}$$

The estimate value of the transmission OFDM symbol including the V matrix of Equation 46 satisfies Equation 47.

$${\hat{x}}^{( data )} = [ \text{} \begin{matrix}{( {Q}_{A}^{( DMRS )} )}^{T} & {0}_{N} \\ {0}_{N} & {( {Q}_{B}^{( DMRS )} )}^{T}\end{matrix} ] V [ \begin{matrix}{P}_{A}^{( data )} & {0}_{N} \\ {0}_{N} & {P}_{B}^{( data )}\end{matrix} ] [ \begin{matrix}{x}_{A 1}^{( data )} \\ {x}_{B 1}^{( data )}\end{matrix} ] \qquad ( Equation 47 )$$

In Equation 47, the equation for the transmission symbol vector of transmitter A among the estimate values of the transmission OFDM symbol vector is summarized as Equation 48.

$$( Equation 48 )$$

$${\hat{x}}_{A 1}^{( data )} = {\underbrace{{( {Q}_{A}^{( DMRS )} )}^{T} {V}_{11} {P}_{A}^{( data )} {x}_{A 1}^{( data )}}}_{intra - TRP interference} + {\underbrace{{( {Q}_{A}^{( DMRS )} )}^{T} {V}_{12} {P}_{B}^{( data )} {x}_{B 1}^{( data )}}}_{inter - TRP interference}$$

The transmission symbol vector estimation equation in Equation 48 can be divided into two parts: intra-TRP interference component and inter-TRP interference component. The intra-TRP interference component is almost the same as the intra-layer in the previous single transmission/reception point example as follows. As in the single transmission/reception point, considering the distortion caused by the own signals as intra-carrier, and the distortion caused by the surrounding signals as inter-carrier interference, the intra-TRP component can be separated into the inter-carrier component and the intra-carrier component as following Equations 49 and 50.

$${\hat{x}}_{A 1 , n}^{( data )} {\vert}_{intra - TRP} = {\hat{x}}_{A 1 , n}^{( data )} {\vert}_{\begin{matrix}intra - TRP \\ intra - carrier\end{matrix}} + {\hat{x}}_{A 1 , n}^{( data )} {\vert}_{\begin{matrix}intra - TRP \\ inter - carrier\end{matrix}} \qquad ( Equation 49 )$$

$$\text{?} \qquad ( Equation 50 )$$

$$\text{?}$$

$$\text{?} \text{indicates text missing or illegible when filed}$$

Next, the inter-TRP interference component can also be summarized as in Equation 51, similarly to the intra-layer interference component in Equation 50.

$$\text{?} \qquad ( Equation 51 )$$

$$\text{?}$$

$$\text{?} \text{indicates text missing or illegible when filed}$$

By adding the intra-TRP and inter-TRP interference components obtained from Equations 50 and 51, the single symbol estimate value of the transmitted OFDM symbol vectors is summarized as Equation 52.

$$\text{?} \qquad ( Equation 52 )$$

$$\text{?} \text{indicates text missing or illegible when filed}$$

In the single symbol estimate value among the transmission OFDM symbol vectors obtained in Equation 52, if there is no ICI of phase noise, that is, if U=0, Equation 52 can be simplified as Equation 53.

[symbol]

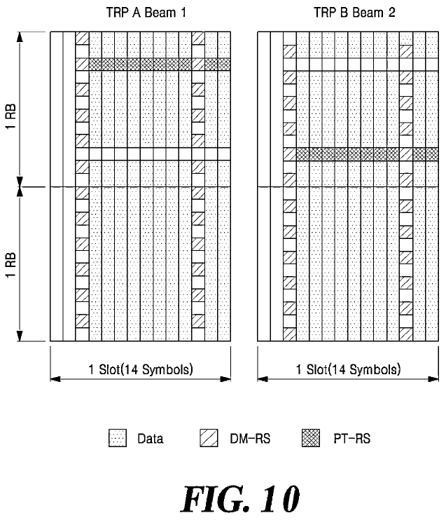

As shown in Equation 53, when U=0, that is, when the effective bandwidth of phase noise is less than the subcarrier interval and the channel estimation is perfect, the inter-TRP interference component also disappears, and the inter-carrier interference component of intra-TRP caused by the phase noise also disappears, showing the same result as the example of the single transmission/reception point. If the general information symbol is transmitted through both transmitter A and transmitter B, and the reference signal for phase noise estimation is transmitted only through either transmitter A or transmitter B to prevent deterioration of phase noise estimation performance due to interference between TRPs, the mapping of the symbols is as shown in FIG. 10 below.

FIG. 10 is an example diagram of symbol allocation in the OFDM scheme in a multiple transmission/reception point environment with a single antenna.

In the environment as shown in FIG. 10, when the receiving terminal estimates the reference signal for phase noise estimation, the estimate value satisfies Equation 54.

$$\text{?} = \{ \begin{matrix}\text{?} & U > 0 \\ \text{?} & U = 0\end{matrix} \qquad ( Equation 54 )$$

$$\text{?} \text{indicates text missing or illegible when filed}$$

In Equation 54, when U=0, that is, when only the CPE component due to phase noise is estimated, it is estimated while all inter-TRP components are ignored, and among the intra-TRP components, the inter-carrier component is also assumed to be 0, so that the reference signal estimate value in the case of U=0 estimates only the intra-carrier component of the intra-TRP, that is, the CPE value. In this case, there is no problem even if the phase noise is estimated through the mapping as shown in FIG. 10. Rather, it can be considered as a mapping capable of improving the reliability of phase noise estimation by reducing inter-TRP interference components that may occur due to channel estimation errors by any chance. However, the situation changes when U>0, that is, when estimating not only the CPE component due to phase noise, but also the entire frequency spectrum of phase noise affecting surrounding subcarriers. As shown in Equation 54, when the reference signal is located at index n, the intra-carrier component of the inter-TRP becomes 0 because the reference signal is transmitted through one beam and not through the other beam, but the remaining intra-carrier component of the inter-TRP and the inter-carrier component of the intra-TRP are all taken into account to estimate the phase noise. As described in the scheme for estimating and compensating for the ICI of phase noise according to one embodiment of the present disclosure, to estimate the entire frequency spectrum of phase noise, not only the OFDM symbol to which the reference signal is mapped but also surrounding general information symbols may be used. However, there is a difference between the estimate value of the received symbol at the location where the reference signal is mapped and the estimate value of the received symbol around the reference signal, as shown in Equation 55.

$$\text{?} \qquad ( Equation 55 )$$

$$\text{?} \text{indicates text missing or illegible when filed}$$

As shown in Equation 55, the received symbols used in estimating ICI due to phase noise do not go through the same environment and have differences in presence or absence depending on reference signal mapping.

When estimating phase noise in the OFDM scheme, when the magnitude of the subcarrier is greater than or equal to the magnitude of the phase noise bandwidth, only the common phase error component (CPE) exists, and there is little interference between adjacent subcarriers, interference between antennas, and interference between transmission/reception points due to residual phase noise. In this case, to prevent interference between reference signals due to channel estimation errors, the phase noise estimation reference signal is allocated to only one antenna or one transmission/reception point per subcarrier frequency resource, and a symbol with zero power is allocated to the remaining antennas or transmission/reception points in the corresponding subcarrier frequency resource, that is, the corresponding subcarrier frequency resource is left empty, thereby increasing the reliability of phase noise estimation. On the other hand, when the magnitude of the subcarrier is less than the magnitude of the phase noise bandwidth, the conventional phase noise estimation reference signal allocation scheme causes many problems. When the bandwidth of the frequency spectrum of phase noise spans several subcarriers, interference between subcarriers due to residual phase noise after channel equalization causes interference between antennas and interference between transmission/reception points. To compensate for this, estimation of the frequency spectrum of the residual phase noise is required, which requires not only the reference signal but also the subcarrier information allocated to the surrounding general data symbols. However, as confirmed in the single transmission/reception point multi-antenna environment and the multiple transmission/reception point single antenna environment, when applying the conventional reference signal mapping method, there is a difference between the channel and interference environment experienced by the reference signal and the channel and interference environment experienced by surrounding data symbols. Therefore, when the frequency spectrum of the residual phase noise is estimated using the reference signal and the surrounding data symbols simultaneously, the reliability of the estimated residual phase noise value is bound to decrease.

One embodiment of the present disclosure provides a reference signal allocation scheme for increasing phase noise estimation performance according to the phase noise environment and subcarrier interval.

In one embodiment of the present disclosure, when the magnitude of the subcarrier is less than the magnitude of the phase noise bandwidth, the environment experienced by the reference signal used in estimating the residual phase noise after channel estimation is made similar to the environment experienced by data symbols to increase the estimation performance of the frequency spectrum of the residual phase noise. In order to make the channel and phase noise environment of the reference signal similar to that of the data symbol in the above-described environment, it may be considered that even for a subcarrier frequency resource that a specific antenna signal or a specific transmission/reception point signal uses to transmit the reference signal, the reference signal or data is transmitted through another antenna signal or another transmission/reception point signal. In such transmission, the interference signal component between antennas or the interference signal component between transmission/reception points at the same subcarrier location can be confirmed among the components that constitute the estimate value of the transmission signal at the reference signal location, which are the same as the configuration of the transmission signal estimate value at the location of the subcarrier to which the general data symbol is allocated. That is, the reference signal and general data symbols experience similar channel and phase noise environments. Considering the phase noise environment and subcarrier interval, the present disclosure proposes a scheme of allocating a reference signal separately in the case of estimating and compensating only the common phase noise and in the case of compensating for the interference component through estimation of the entire spectrum of the phase noise, thereby increasing the reliability of the residual phase noise estimate after channel estimation and equalization.

When only the common phase error component (CPE) is estimated and compensated for the case where the magnitude of the subcarrier is greater than or equal to the magnitude of the phase noise bandwidth, the conventional resource allocation scheme of allocating the reference signal for phase noise estimation to only one antenna or one transmission/reception point for each subcarrier frequency resource and leaving the remaining antennas or transmission/reception points for the corresponding subcarrier frequency resource empty may be used to prevent interference between reference signals caused by channel estimation errors. In this case, in the single transmission/reception point multi-antenna environment, the transmission symbol estimate value is as shown in Equation 56.

$$\text{?} \qquad ( Equation 56 )$$

$$\text{?} \text{indicates text missing or illegible when filed}$$

In Equation 56, \hat{x}_{A1,r}^{(data)} is the estimate value of the transmission reference signal at the subcarrier index r where the reference signal is located among the OFDM symbol vectors transmitted from the transmission/reception point A, \tilde{p}_{A,0}^{(data)} and \tilde{p}_{R,0}^{(data)}. represent the residual phase noise at the transmission/reception point A and the residual phase noise of the receiver, respectively. Both residual phase noise components are common phase noise that occurs for all subcarrier signals regardless of the subcarrier index r, which can be compensated for using the resource allocation scheme described above. Even in the single antenna, multiple transmission/reception point environment, results as Equation 57 can be confirmed.

$$\text{?} \qquad ( Equation 57 )$$

$$\text{?} \text{indicates text missing or illegible when filed}$$

Next, when the magnitude of the subcarrier is less than the magnitude of the phase noise bandwidth, the subcarrier frequency resource that a specific antenna signal or a specific transmission/reception point signal uses to transmit the reference signal is also allocated to transmit the reference signal or data through another antenna signal or another transmission/reception point signal. In such transmission, the transmission QAM symbol estimate value in the single transmission/reception point multiple antenna environment can be expressed as Equation 58.

$$\{ \begin{matrix}\text{?} \\ \text{?}\end{matrix} \qquad ( Equation 58 )$$

$$\text{?} \text{indicates text missing or illegible when filed}$$

In Equation 58, \tilde{x}_{A1,r}^{(data)} is the transmission reference signal estimate value at the (data) subcarrier index r where the reference signal is located among the OFDM symbol vectors transmitted from the transmission/reception point A, and \hat{x}_{A1,n}^{(data)} is the transmission data signal estimate value at the subcarrier index n where the general data symbol is located among the OFDM symbol vectors transmitted from the transmission/reception point A. As shown in Equation 57, among the components constituting the transmission signal estimate value at the reference signal location, the inter-antenna interference signal component at the same subcarrier location can be confirmed. In this case, the channel and phase noise environments experienced by the reference signal and the general data symbol are almost similar. The transmission QAM symbol estimate value in the multiple transmission/reception point environment with a single antenna is also the same as in the above case.

$$\{ \begin{matrix}\text{?} \\ \text{?}\end{matrix} \qquad ( Equation 59 )$$

$$\text{?} \text{indicates text missing or illegible when filed}$$

As shown in Equation 57, for reference signals and data symbols subjected to the same environment, as described above, a de-ICI filter or a frequency spectrum of phase noise for removing ICI caused by phase noise at transmission/reception point A using the symbol vector transmitted by transmission/reception point A can be configured in the manner shown in Equation 60.

$$\text{?} ‖ [ \begin{matrix}\text{?} & … & \text{?} \\ ⋮ & ⋱ & ⋮ \\ \text{?} & … & \text{?}\end{matrix} ] [ \begin{matrix}\text{?} \\ ⋮ \\ \text{?}\end{matrix} ] [ \begin{matrix}\text{?} \\ ⋮ \\ \text{?}\end{matrix} ] \text{?} \qquad ( Equation 59 )$$

$$\text{?}$$

$$\text{?} \text{indicates text missing or illegible when filed}$$

In Equation 60, since the channel and phase noise environments experienced by the component {\hat{x}_{A1,r}_{ᵢ}^{(data)}|0≤i<R} corresponding to the reference signal location and the component {\hat{x}_{A1,r}_{ᵢ}₊ᵤ^{(data)}|0≤i<R, −U≤u≤U, u≠0} corresponding to the data symbol location among the components of the \hat{x}_{A1,r}^{(data)} matrix for estimating the de-ICI filter Â, are consistent, the filter estimate value Â is expected to be more reliable than the value estimated from the conventional resource allocation scheme. The embodiment of the present disclosure controls the resource allocation scheme of the reference signal according to the frequency spectrum characteristics of the phase noise and the subcarrier interval of the orthogonal frequency division multiplexing scheme in the multi-antenna and multi-transmission/reception point environment to improve the phase noise estimation performance and the distortion compensation performance of the received signal in the environment.

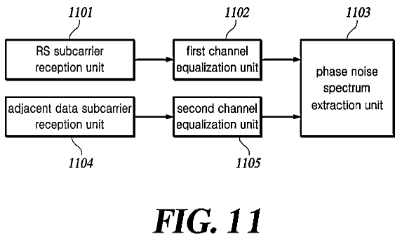

When the magnitude of the subcarrier is greater than or equal to the magnitude of the phase noise bandwidth, the phase noise can be adequately estimated and compensated for by a commonly known resource allocation scheme for phase noise estimation, i.e., a resource allocation scheme of allocating a phase noise estimation reference signal at only one antenna or one transmission/reception point per subcarrier frequency resource and leaving the corresponding subcarrier frequency resource empty at the remaining antennas or transmission/reception points. However, as described in the single transmission/reception point multi-antenna environment and the multiple transmission/reception point single antenna environment, when the magnitude of the subcarrier is less than the magnitude of the phase noise bandwidth, interference between subcarrier resources due to phase noise and the resulting inter-antenna interference or inter-transmission/reception interference occurs. In this case, in order to compensate for signal distortion caused by phase noise, it is necessary to directly estimate the frequency spectrum of the phase noise or to estimate the coefficients of the de-ICI filter to compensate for the frequency spectrum of the phase noise. In this case, not only the reference signal for channel estimation but also the signal of the subcarrier resource to which general data symbols are allocated are simultaneously utilized. FIG. 11 shows an example of a process for using the received reference signal subcarrier and surrounding data subcarrier to estimate the frequency spectrum of phase noise that commonly distorts the corresponding subcarriers or the coefficients of a phase noise compensation filter.

FIG. 11 is an example diagram of spectrum estimation of phase noise with a wide band using received subcarriers.

The receiver in FIG. 11 includes an RS subcarrier reception unit 1101, a first channel equalization unit 1102, a phase noise spectrum extraction unit 1103, an adjacent data subcarrier reception unit 1104, a second channel equalization unit 1105, and the like.

The RS subcarrier receiving unit 1101 receives a RS signal.

The first channel equalization unit 1102 applies an equalization matrix to the received RS signal and outputs it to minimize the mean square error using an interference cancellation technique.

The adjacent data subcarrier receiving unit 1104 receives adjacent data.

The second channel equalization unit 1105 applies an equalization matrix to the received adjacent data and outputs it.

The phase noise spectrum extraction unit 1103 applies the interference cancellation technique to the output of each of the first channel equalization unit 1102 and the second channel equalization unit 1105 and outputs them.

As shown in FIG. 11, when the magnitude of the subcarrier is less than the magnitude of the phase noise bandwidth, phase noise estimation and compensation is performed by receiving both the reference signal subcarrier signal and the data subcarrier signal around the reference signal, and after channel estimation and comparing with the transmission reference signal, extracting the phase noise spectrum or phase noise compensation filter coefficients based on the reference signal of each subcarrier. In this way, when using both the reference signal subcarrier and the data subcarrier, it is important that the subcarriers all experience similar channel and phase noise environments to improve the reliability of phase noise spectrum estimation. In the case of a single antenna, single transmission/reception point environment, all subcarriers experience a channel corresponding to each subcarrier and are also affected by the same phase noise spectrum. However, in a multi-antenna or multi-transmission/reception point environment, in a case of resource allocation scheme where the reference signal for phase noise estimation is transmitted through one antenna or one transmission/reception point and the corresponding carrier resource is left empty at other antennas or transceiver points, while the reference signal subcarrier resource is not affected by inter-antenna interference or inter-transmission/reception point interference, adjacent data subcarrier resources used for frequency spectrum estimation of phase noise are affected by inter-antenna interference and inter-transmission/reception point interference. Therefore, all subcarrier resources utilized in the frequency spectrum of phase noise do not experience similar channel and phase noise environments.

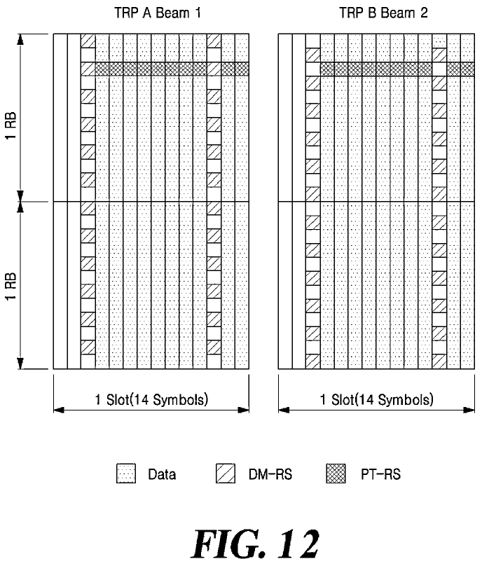

To address this, the reference signal may be equally allocated to all antennas or all transmission/reception point resources as shown in FIG. 12 below.

FIG. 12 is a first example diagram showing a reference signal allocation scheme of the OFDM modulation/demodulation scheme in a multiple transmission/reception point environment according to one embodiment of the present disclosure.

FIG. 12 is a resource allocation scheme that transmits a reference signal through all transmission/reception points rather than transmitting the reference signal through one transmission/reception point in the multiple transmission/reception point environment and emptying the corresponding resources for the remaining transmission/reception points. In such resource allocation, just as the data subcarriers around the reference signal are affected by inter-transmission/reception point interference, the reference signal subcarriers are also affected by inter-transmission/reception point interference, so all subcarriers used in estimating the frequency spectrum of phase noise experience similar channel and phase noise effects. On the contrary, a scheme in which the multi-antenna or multi-transmission/reception point environment, not only the reference signal resources but also all subcarrier resources used in the frequency spectrum of the phase noise are transmitted from one transmission/reception point or one antenna, and the corresponding subcarrier resources are left empty at other transmission/reception points or other antennas, may also be considered.

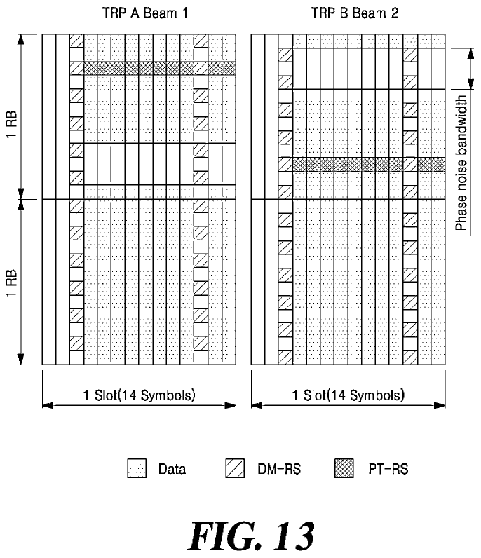

FIG. 13 shows a resource allocation scheme in which not only the subcarrier resources for the reference signal, but also the adjacent data subcarrier resources used for frequency spectrum estimation of phase noise are used only at one transmission/reception point.

FIG. 13 is a second example diagram showing a reference signal allocation scheme of the OFDM modulation/demodulation scheme in a multiple transmission/reception point environment according to one embodiment of the present disclosure.

FIG. 13 shows a resource allocation scheme in which, in a multiple transmission/reception point environment, when transmitting a reference signal through one transmission/reception point and leaving the corresponding resources empty for the remaining transmission/reception points, data subcarrier resources around the reference signal used for phase noise estimation are also left empty and do not perform transmission. When allocating resources in this way, just as the reference signal is not affected by interference from other transmission/reception points, the data subcarriers around the reference signal are also not affected by inter-transmission/reception point interference, so all subcarriers used in estimation of the frequency spectrum of phase noise experience similar channel and phase noise effects.

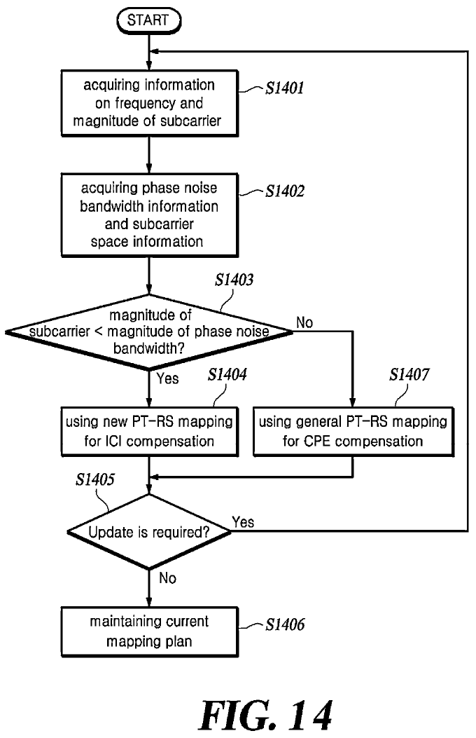

In the multi-antenna and multi-transmission/reception point environment, reference signal resource allocation for phase noise estimation may be determined according to the magnitude of the subcarriers and the phase noise bandwidth in the OFDM scheme. When the magnitude of the subcarrier is greater than or equal to the magnitude of the phase noise bandwidth, only a common phase noise component that is unrelated to the subcarrier index exists, and when channel estimation and compensation are properly performed, the impact of inter-antenna interference and inter-transmission/reception point interference is relatively low even in the multi-antenna and multi-transmission/reception point environment. Therefore, in this case, phase noise estimation can be performed using the conventional reference signal resource allocation scheme. However, on the contrary, when the magnitude of the subcarrier is less than the magnitude of the phase noise bandwidth, there are interference between subcarrier resources due to phase noise and the resulting inter-antenna interference or inter-transmission/reception point interference, so interference components in addition to the common phase noise mentioned above need to be compensated to ensure the performance of the system. In this case, a resource allocation scheme suitable for frequency spectrum estimation of phase noise may be used rather than the conventional reference signal resource allocation scheme. The following FIG. 14 shows an example of a flowchart of a procedure for determining a reference signal resource allocation scheme based on the relationship between the magnitude of the frequency bandwidth of phase noise and the magnitude of the subcarrier.

FIG. 14 is a flowchart showing a method of determining a resource allocation scheme based on the frequency spectrum of phase noise according to one embodiment of the present disclosure.

As shown in FIG. 14, the system acquires frequency bandwidth information of phase noise (information on magnitude of phase noise bandwidth) and information on magnitude of subcarriers in steps 1401 and 1402. Since the frequency bandwidth of phase noise is generally closely related to the frequency of the carrier, as an example of acquiring the frequency bandwidth information of the phase noise, the frequency information of the carrier may be used as shown in FIG. 14. After acquiring the magnitude information of the phase noise bandwidth and the magnitude information of the subcarrier, the system compares the magnitudes in step 1403.

As a result of the comparison, when the system determines that it is necessary to remove the interference component due to phase noise, that is, when the magnitude of the subcarrier is less than the magnitude of the phase noise bandwidth, the system uses the resource allocation scheme that applies the reference signal allocation scheme as in the example of FIG. 12 or FIG. 13 presented in the present disclosure (step 1404).

In contrast, when the system determines that there is little interference component due to phase noise, that is, when the magnitude of the subcarrier is greater than or equal to the magnitude of the phase noise bandwidth, the system uses the resource allocation scheme that applies the reference signal allocation scheme as in the example of FIG. 10 presented in the present disclosure (step 1407).

According to the present disclosure, it is possible to increase the reliability of frequency spectrum estimation of phase noise by reducing channel estimation error when using the OFDM modulation scheme in the multi-transmission/reception point environment.

Subsequently, as in step 1405, when the phase noise bandwidth is changed or the magnitude of the subcarrier is changed, the system may proceed with the above procedure again.

The operation of FIG. 14 is applicable to both the transmitting side and the receiving side, and the side opposite to the side that performs the operation of FIG. 14 receives a signal, extracts a reference signal from the signal, and estimates an OFDM symbol based on the reference signal. The OFDM symbol acquires the magnitude of the phase noise bandwidth, obtains the magnitude of the subcarrier, compares the magnitude of the frequency bandwidth and the magnitude of the subcarrier, selecting one of a first phase compensation scheme and a second first phase compensation scheme based on the comparison result, and inserting the reference signal into the OFDM symbol based on the selected phase compensation scheme.

At least some of the components described in the exemplary embodiments of the present disclosure may be implemented as hardware elements including at least one or a combination of a digital signal processor (DSP), a processor, a network control unit, application-specific IC (ASIC), a programmable logic device (FPGA, etc.), and other electronic devices. In addition, at least some of the functions or processes described in the exemplary embodiments may be implemented as software, and the software may be stored on a recording medium. At least some of the components, functions, and processes described in the exemplary embodiments of the present disclosure may be implemented as a combination of hardware and software.

The methods according to the exemplary embodiments of the present disclosure may be written as a program that can be executed on a computer, and may also be implemented in various recording mediums such as a magnetic storage medium, an optical readout medium, and a digital storage medium.

Implementations of the various techniques described herein may be made as digital electronic circuitry, or as computer hardware, firmware, software, or combinations thereof. The Implementations may be made as computer program products, i.e., computer programs tangibly embodied in an information carrier, e.g., a machine-readable storage device (computer-readable medium) or a radio signal, for processing through or controlling the operation of a data processing device, e.g., a programmable processor, a computer, or a plurality of computers. Computer programs, such as the computer program(s) described above, may be written in any form of programming language, including compiled or interpreted languages, and may be deployed as a stand-alone program or in any form including as a module, component, subroutine, or other units suitable for use in a computing environment. The computer program may be deployed to be processed on one computer or multiple computers at one site or distributed across multiple sites and interconnected by a communications network.

Processors suitable for processing computer programs include, for example, both general-purpose and special-purpose microprocessors, and any one or more processors of any type of digital computer. Typically, the processor will receive instructions and data from read-only memory or random access memory, or both. Elements of the computer may include at least one processor that executes instructions and one or more memory devices that store instructions and data. In general, the computer may include one or more mass storage devices that store data, such as magnetic disks, magneto-optical disks, or optical disks, or may be coupled to receive data from them, transmit data to them, or perform both. Information carriers suitable for embodying computer program instructions and data include, for example, semiconductor memory devices, magnetic media such as hard disks, floppy disks, and magnetic tapes, optical media such as CD-ROM (Compact Disk Read Only Memory), and DVD (Digital Video Disk), magneto-optical media such as floptical disk, ROM (Read Only Memory), RAM (Random Access Memory), flash memory. EPROM (Erasable Programmable ROM). EEPROM (Electrically Erasable Programmable ROM), and the like. The processor and memory may be supplemented by or included in special purpose logic circuitry.

What is claimed is:

1. A method of designing a reference signal for phase noise estimation in an orthogonal frequency division multiplexing (OFDM) communication system, the method comprising:
acquiring a magnitude of a frequency bandwidth of phase noise;
acquiring a magnitude of a subcarrier;
comparing the magnitudes of the subcarrier and the frequency bandwidth;
selecting one of a first phase compensation scheme and a second phase compensation scheme based on the comparison result, and inserting the reference signal into an OFDM symbol based on the selected phase compensation scheme; and
transmitting the OFDM symbol including the reference signal.

2. The method of claim 1, wherein the inserting the reference signal into the OFDM symbol includes selecting the first phase compensation scheme when the magnitude of the subcarrier is less than the magnitude of the frequency bandwidth.

3. The method of claim 2, wherein the first phase compensation scheme is a scheme that a transmitter allocates a first (phase tracking-reference signal) PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter vacates resources for PT-RSs corresponding to in a frequency axis to the first PT-RS set and resources for data subcarriers adjacent to the resources for the PT-RSs, in the remaining TRP.

4. The method of claim 2, wherein the first phase compensation scheme is a scheme that a transmitter allocates a first PT-RS set consisting of a plurality of PT-RSs to one TRP and does not vacate resources corresponding to a frequency axis with the first PT-RS set to the remaining TRPs, and allocate a second PT-RS set consisting of a plurality of PT-RS to the resources of the remaining TRPs.

5. The method of claim 1, wherein the inserting the reference signal into the OFDM symbol includes selecting the second phase compensation scheme when the magnitude of the subcarrier is greater than or equal to the magnitude of the frequency bandwidth.

6. The method of claim 5, wherein the second phase compensation scheme is a scheme that a transmitter allocates a first PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter reserves resources for PT-RSs corresponding in a frequency axis to the first PT-RS set, in the remaining TRP.

7. A device for designing a reference signal for phase noise estimation in an orthogonal frequency division multiplexing (OFDM) communication system, the device comprising:
a memory including instructions; and
a processor that executes the instructions to:
obtain a magnitude of a frequency bandwidth of phase noise;
obtain a magnitude of a subcarrier;
compare the magnitudes of the subcarrier and the frequency bandwidth;
select one of a first phase compensation scheme and a second phase compensation scheme based on the comparison result, and insert the reference signal into an OFDM symbol based on the selected phase compensation scheme; and
transmit the OFDM symbol including the reference signal.

8. The device of claim 7, wherein the processor selects the first phase compensation scheme when the magnitude of the subcarrier is less than the magnitude of the frequency bandwidth.

9. The device of claim 8, wherein the first phase compensation scheme is a scheme that a transmitter allocates a first PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter vacates resources for PT-RSs corresponding to in a frequency axis to the first PT-RS set and resources for data subcarriers adjacent to the resources for the PT-RSs, in the remaining TRP.

10. The device of claim 8, The first phase compensation scheme is a scheme that a transmitter allocates a first PT-RS set consisting of a plurality of PT-RSs to one TRP and does not vacate resources corresponding to a frequency axis with the first PT-RS set to the remaining TRPs, and allocate a second PT-RS set consisting of a plurality of PT-RS to the resources of the remaining TRPs.

11. The device of claim 7, wherein the processor selects the second phase compensation scheme when the magnitude of the subcarrier is greater than or equal to the magnitude of the frequency bandwidth.

12. The device of claim 11, wherein the second phase compensation scheme is a scheme that a transmitter allocates a first PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter reserves resources for PT-RSs corresponding in a frequency axis to the first PT-RS set, in the remaining TRP.

13. A method of designing a reference signal for phase noise estimation in an orthogonal frequency division multiplexing (OFDM) communication system, the method comprising:
receiving a signal;
extracting a reference signal from the signal; and
estimating an OFDM symbol based on the reference signal,
wherein the OFDM symbol is generated by acquiring a magnitude of a frequency bandwidth of phase noise, acquiring a magnitude of a subcarrier, comparing the magnitudes of the subcarrier and the frequency bandwidth, selecting one of a first phase compensation scheme and a second phase compensation scheme based on the comparison result, inserting the reference signal into an OFDM symbol based on the selected phase compensation scheme, and transmitting the OFDM symbol including the reference signal.

14. The method of claim 13, wherein the inserting the reference signal into the OFDM symbol includes selecting the first phase compensation scheme when the magnitude of the subcarrier is less than the magnitude of the frequency bandwidth.

15. The method of claim 14, wherein the first phase compensation scheme is a scheme that a transmitter allocates a first PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter vacates resources for PT-RSs corresponding to in a frequency axis to the first PT-RS set and resources for data subcarriers adjacent to the resources for the PT-RSs, in the remaining TRP.

16. The method of claim 14, wherein the first phase compensation scheme is a scheme that a transmitter allocates a first PT-RS set consisting of a plurality of PT-RSs to one TRP and does not vacate resources corresponding to a frequency axis with the first PT-RS set to the remaining TRPs, and allocate a second PT-RS set consisting of a plurality of PT-RS to the resources of the remaining TRPs.

17. The method of claim 13, wherein the inserting the reference signal into the OFDM symbol includes selecting the second phase compensation scheme when the magnitude of the subcarrier is greater than or equal to the magnitude of the frequency bandwidth.

18. The method of claim 17, wherein the second phase compensation scheme is a scheme that a transmitter allocates a first PT-RS set consisting of a plurality of PT-RSs to a transmission/reception point (TRP), and allocates a second PT-RS set consisting of a plurality of PT-RSs to the remaining TRPs not to overlap in a frequency axis with the first PT-RS set,
wherein the transmitter reserves resources for PT-RSs corresponding in a frequency axis to the first PT-RS set, in the remaining TRP.
